(19) United States
(12) Patent Application Publication
(10) Pub. No.: US 2019/0071014 A1
(43) Pub. Date: Mar. 7, 2019

(54) SYSTEM FOR OBJECT INDICATION ON A VEHICLE DISPLAY AND METHOD THEREOF

(71) Applicant: HONDA MOTOR CO., LTD, Tokyo (JP)

(72) Inventor: Teruhisa MISU, Mountain View, CA (US)

(21) Appl. No.: 15/693,740

(22) Filed: Sep. 1, 2017

(51) Int. Cl. B60R 1/00; G06K 9/00; G06T 11/60; G08G 1/16; G02B 27/01

(52) U.S. Cl. CPC B60R 1/00; G06K 9/00805; G06T 11/60; G08G 1/166; G06T 3/60; B60R 2300/205; B60R 2300/308; B60R 2300/8093; G02B 27/0101

(57) ABSTRACT

Presence of an object can be indicated on a display of a vehicle. An avatar can be displayed on the display of the vehicle indicating a travel direction of the vehicle. Presence of the object can be detected within a path in the travel direction of the vehicle, where the path corresponds to an area on the display of the vehicle. A beam can be drawn from the avatar to the object as an alert of the presence of the object.

### BACKGROUND

Vehicles can be equipped with displays, such as a heads-up display (HUD) that projects information onto a windshield of the vehicle, an infotainment display typically situated within a dash or console of the vehicle, etc. The displays can present information related to operating the vehicle, such as a speed of the vehicle, direction of the vehicle, navigation ques to assist a vehicle operator when driving the vehicle.

### SUMMARY

The following presents a simplified summary of one or more aspects of the disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the disclosure in a simplified form as a prelude to the more detailed description that is presented later.

In an example, a method for indicating presence of an object on a display of a vehicle is provided. The method includes displaying, on the display of the vehicle, an avatar indicating a travel direction of the vehicle, detecting presence of the object within a path in the travel direction of the vehicle, where the path corresponds to an area on the display of the vehicle, and displaying, on the display of the vehicle, a beam drawn from the avatar to the object as an alert of the presence of the object.

In another example, a vehicle is provided that includes an electronic control unit for communicating with at least one vehicle system, a display for displaying an avatar based on a travel direction of the vehicle, and a beam to indicate presence of an object near the vehicle, and at least one processor. The at least one processor is configured to detect, via the electronic control unit, presence of the object within a path in the travel direction of the vehicle, where the path corresponds to an area on the display of the vehicle, and cause displaying, on the display of the vehicle, the beam drawn from the avatar to the object as an alert of the presence of the object.

In a further example, a non-transitory computer-readable medium storing computer executable code for indicating presence of an object on a display of a vehicle is provided. The code includes code for displaying, on the display of the vehicle, an avatar indicating a travel direction of the vehicle, detecting presence of the object within a path in the travel direction of the vehicle, where the path corresponds to an area on the display of the vehicle, and displaying, on the display of the vehicle, a beam drawn from the avatar to the object as an alert of the presence of the object.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects can be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 illustrates a schematic view of an example operating environment of a vehicle display system according to one aspect of the disclosure;

FIG. 2 illustrates a flowchart showing an example method for indicating presence of an object on a vehicle display according to one aspect of the disclosure;

FIG. 3 illustrates a specific non-limiting example of a heads-up display indicating presence of an object according to one aspect of the disclosure;

FIG. 4 presents an example system diagram of various hardware components and other features according to one aspect of the disclosure; and

FIG. 5 is a block diagram of various example system components according to one aspect of the disclosure.

### DETAILED DESCRIPTION

The following includes definitions of selected terms employed herein. The definitions include various examples and/or forms of components that fall within the scope of a term and that can be used for implementation. The examples are not intended to be limiting.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

The term “location,” as used herein, can refer to a position of an object in space. A location can be indicated using a coordinate system. For example, a location can be represented as a longitude and latitude. In another aspect, a location can include a height. Moreover, in an example, the location can be relative to an object, such as a device detecting location of another device, and the location can be indicated based on the device detecting the location.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected,” is one in which signals, physical communications, and/or logical communications can be sent and/or received. An operable connection can include a physical interface, a data interface and/or an electrical interface.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “vehicle,” as used herein, can refer to any moving vehicle that is capable of carrying one or more human occupants and is powered by any form of energy. The term “vehicle” can include, but is not limited to: cars, trucks, vans, minivans, SUVs, motorcycles, scooters, boats, personal watercraft, and aircraft. In some cases, a motor vehicle includes one or more engines.

The term “vehicle operator,” as used herein, can refer to an entity (e.g., a person or other being, robot or other mobile unit, etc.) that can operate a vehicle. The vehicle operator can carry a remote device or other mechanism for activating one or more vehicle systems or other components of the vehicle.

The term “vehicle system,” as used herein, can refer to an electronically controlled system on a vehicle operable to perform certain actions on components of the vehicle, which can provide an interface to allow operation by another system or graphical user interaction. The vehicle systems can include, but are not limited to, vehicle ignition systems, vehicle heating, ventilating, and air conditioning (HVAC) systems, vehicle audio systems, vehicle security systems, vehicle video systems, vehicle infotainment systems, vehicle telephone systems, and the like.

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

Several aspects of certain systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements can be implemented using electronic hardware, computer software, or any combination thereof. Whether such elements are implemented as hardware or software depends upon the particular application and design constraints imposed on the overall system.

By way of example, an element, or any portion of an element, or any combination of elements can be implemented with a “processing system” that includes one or more processors. One or more processors in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, whether referred to as software, firmware, middleware, microcode, hardware description language, or otherwise.

Accordingly, in one or more aspects, the functions described can be implemented in hardware, software, firmware, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

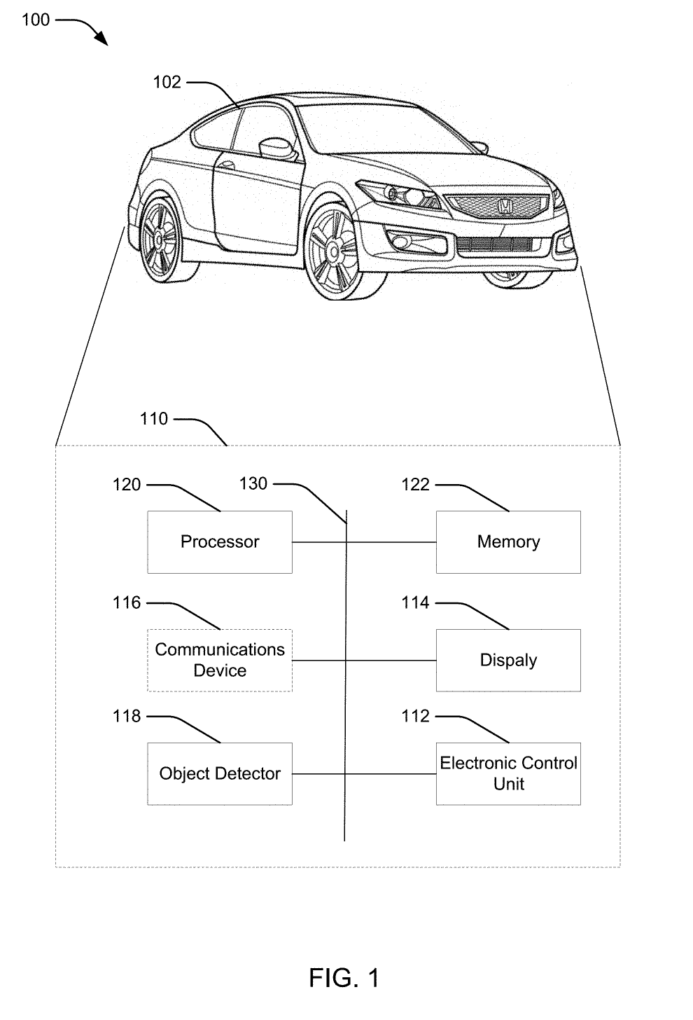

FIG. 1 shows a schematic view of an example operating environment 100 of a vehicle display system 110 and example methods according to aspects described herein. For example, operating environment 100 can include a vehicle 102 within which the vehicle display system 110 can reside and function. Components of the vehicle display system 110, as well as the components of other systems, hardware architectures and software architectures discussed herein, can be combined, omitted or organized into different architectures for various aspects of the disclosure. However, the example aspects and configurations discussed herein focus on the operating environment 100 as illustrated in FIG. 1, with corresponding system components and related methods.

As shown in FIG. 1, a vehicle 102 can include or can be operably coupled with a vehicle display system 110, which can include a heads-up display (HUD) configured to project images on a windshield for viewing by a vehicle operator, an infotainment system configured to display information in a dash or console of the vehicle 102 for viewing by the vehicle operator, and/or the like. The vehicle display system 110 can include, or can be communicatively coupled with, an electronic control unit (ECU) 112 that operably controls a plurality of vehicle systems. The vehicle systems can include, but are not limited to, the vehicle display system 110, among others, including vehicle telematics systems that communicate data regarding operating the vehicle, such as vehicle speed, engine temperature, fuel level, vehicle health statistics, vehicle HVAC systems, vehicle audio systems, vehicle security systems, vehicle video systems, vehicle telephone systems, and the like. For example, ECU 112 can control and/or communicate with many electrical, mechanical, electromechanical aspects of the vehicle starting/shutting down of an ignition of the vehicle, operation of the HVAC system to circulate air in the vehicle, operation of door locks, windows and an audio system, among other functions, and/or can provide a graphical user or programmatic interface to allow operators or other devices (e.g., processor 120 executing functions described herein) to control such aspects of the vehicle 102.

The vehicle display system 110 can include, or be operably coupled with, a display 114, which can include a projector for emitting light corresponding to images for displaying on a windshield of the vehicle 102, a liquid crystal display (LCD) integrated in an infotainment system in the vehicle 102. The vehicle display system 110 can also include, or be operably coupled with, one or more communications devices 116 for communicating with one or more remote systems using an electronic communication technology (such as RFID, NFC, Bluetooth®, ZigBee, etc.). The vehicle display system 110 can also include, or be operably coupled with, an object detector 118 that can detect presence of, distance or direction to one or more objects outside of the vehicle 102. For example, the object detector 118 can include an infrared or heat sensor, a radar device, a camera, etc. In another example, the object detector 118 can be coupled with an identification mechanism that can identify a detected object (e.g., based on a temperature of the object, an outline of the object, a detected movement or acceleration of the object, etc.).

The vehicle display system 110 can also include or be operably coupled with (or executed by) one or more processors 120 and one or more memories 122 that communicate to effectuate certain actions at the vehicle 102 (e.g., actions on or associated with one or more of ECU 112, display 114, communications device(s) 116, object detector 118, and/or other components described herein). In one example, one or more of the ECU 112, display 114, communications device(s) 116, object detector 118, processor(s) 120 and/or memory(ies) 122 can be connected via one or more buses 130.

In addition, the ECU 112 can additionally or alternatively include a processor, memory (e.g., internal processing memory), an interface circuit, and/or buses for transferring data, sending commands, and communicating with the vehicle systems (not shown). In addition, communications device 116, as described, can include substantially any wireless device or related modem for providing wireless computer communications utilizing various protocols to send/receive electronic signals internally to features and systems within the vehicle 102 and/or to external devices. In an example, communications device 116 can communicate according to one or more wireless systems (e.g., RFID, IEEE 802.11, IEEE 802.15.1 (Bluetooth®)), NFC (e.g., ISO 13157), a local area network (LAN), and/or a point-to-point system, etc.).

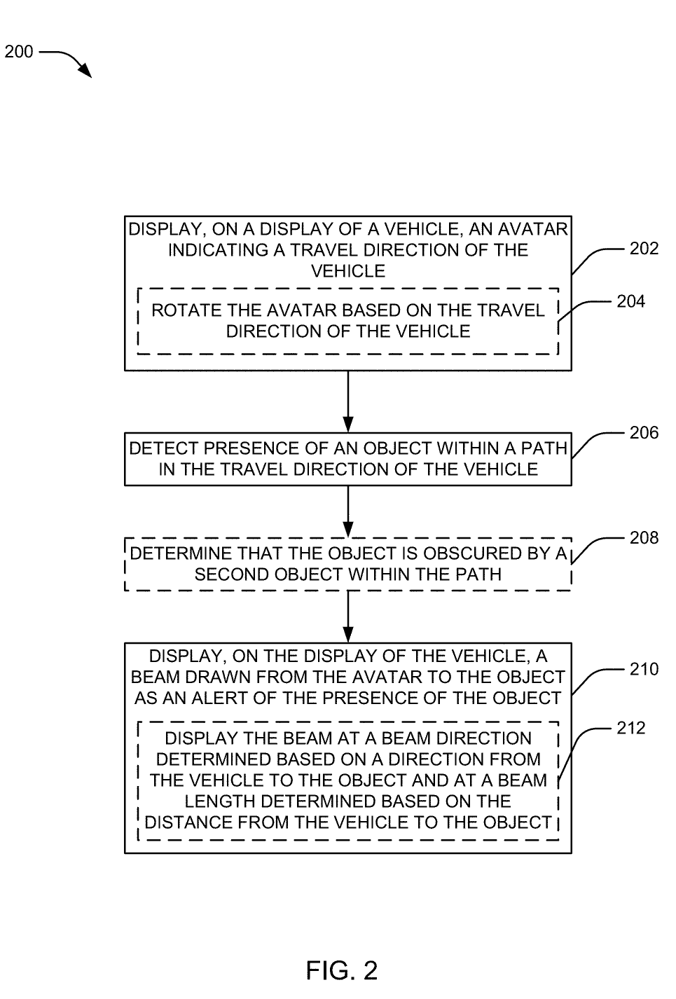

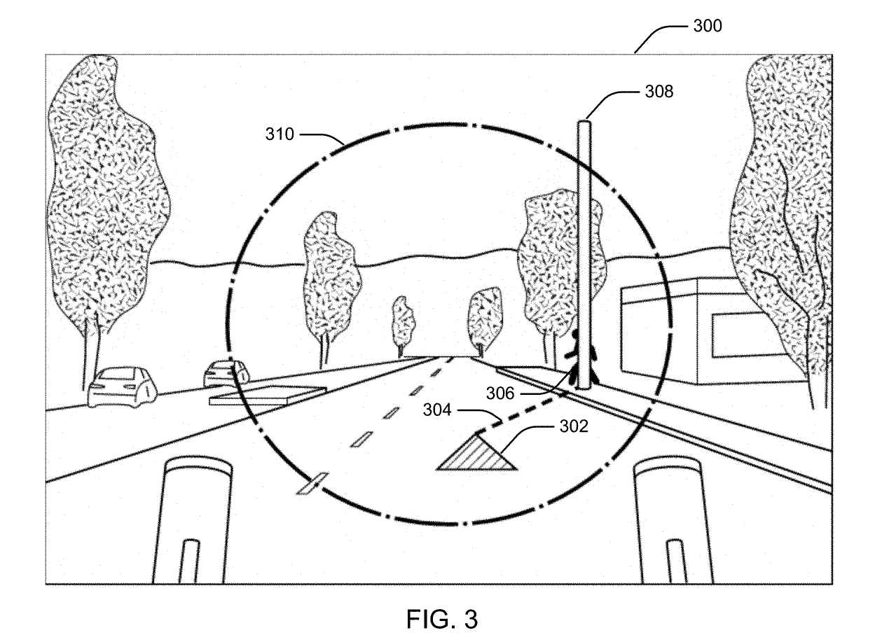

Referring now to FIG. 2, an example method 200 that can be utilized by the vehicle display system 110 is illustrated. In block 202, the method 200 can include displaying, on a display of a vehicle, an avatar indicating a travel direction of the vehicle. In an aspect, vehicle display system 110, e.g., in conjunction with display 114, processor 120, memory 122, can display the avatar indicating the travel direction of the vehicle 102. In one example, vehicle display system 110 can display the avatar as a shape having an angular edge, such as a triangle, where the angular edge can point in the travel direction of the vehicle 102. For example, the travel direction can be oriented based on a front of the vehicle, and thus the avatar can indicate the travel direction with respect to the front of the vehicle. An example is depicted in FIG. 3 where an avatar 302 is displayed via the display 114 (e.g., based on projecting the avatar 302 in a heads-up display on a windshield 300) pointing in the travel direction forward of the vehicle. The avatar can be of substantially any shape, however, that may or may not have the angular edge, such as a rectangle, a vehicle shape or outline, etc.

In one example, displaying the avatar at block 202 can optionally include, at block 204, rotating the avatar based on the travel direction of the vehicle. In an aspect, vehicle display system 110, e.g., in conjunction with display 114, processor 120, memory 122 can rotate the avatar based on the travel direction of the vehicle. In an example, the vehicle display system 110 can determine an orientation or rotational position for the avatar on the display 114 based at least in part on a rotational position (e.g., a yaw) of a steering column of the vehicle 102, a wheel of the vehicle 102, which can be determined based on information received from one or more ECUs 112 that communicates, senses, or otherwise determines such information from mechanical and/or electromechanical parts of the vehicle. In this example, vehicle display system 110 can determine an orientation for the avatar 302 on the display 114 based on an interpolation of the rotational position of the steering column, wheel(s) onto a coordinate space displayed via the display 114. In other examples, the avatar can be displayed in a static position.

At block 206, method 200 can also include detecting presence of an object within a path in the travel direction of the vehicle. In an aspect, vehicle display system 110, e.g., in conjunction with one or more ECUs 112, object detector 118, processor 120, memory 122 can detect presence of the object within the path in the travel direction of the vehicle. For example, the object detector 118 can include one or more sensors that can detect presence of objects, such as an infrared or heat sensor, optical sensor, radar, camera, as described, to detect presence of objects, which may include one or more of structural inanimate objects, animate objects, and can do so within the path where the path can correspond to an area in front of the vehicle that can be analyzed by the object detector 118 to detect objects. In one example, the path can correspond to, or at least include, a drawing area associated with the display 114 such that detected objects can be highlighted on the display 114 in the drawing area (e.g., based on interpolating location of the objects as detected by the object detector 118 to a coordinate space of the drawing area, as described further herein).

In an example, the object detector 118 can be configured to identify detected objects, or at least identify a type of the detected objects. For example, object detector 118 can be configured to determine a type of a detected object at a general level (e.g., animate or inanimate) or more specific identification (e.g., a sign, a tree, a road, a human, an animal or other living being, etc.). For example, the object detector 118 can be configured to differentiate between animate and inanimate objects. In one example, the vehicle display system 110 can utilize multiple sensors, and may determine an object type based on the sensor used to identify the objects (e.g., one type of sensor on the vehicle 102 can detect animate objects, such as an infrared or heat sensor, and another type of sensor on the vehicle 102 can detect inanimate objects, such as a radar or camera). In either case, in an example, the object detector 118 can also be configured to detect objects based at least in part on determining an outline profile of the objects, and/or using machine-learning (e.g., neural networks) to match the profile to a certain type of object, etc. The vehicle display system 110 can utilize the type of object to determine a function for displaying a beam on the display 114, as described further herein.

In an example, the object detector 118 can be associated with, e.g., and/or calibrated with respect to, an area in front the vehicle to allow for determining location information of the detected object with respect to the vehicle. For example, the location information can include a distance from the vehicle to a detected object, a direction of detected object from the vehicle (e.g., related to the distance), etc. In this regard, detecting the presence of the object can also include detecting the direction and/or distance from the vehicle 102 to the object or other location information of the object, which can be graphically represented on the display 114, as described further herein, based on interpolating the location information (e.g., the detected direction and/or distance) to a coordinate space for highlighting the object on the display 114.

In an example, optionally at block 208, method 200 can include determining that the object is obscured by a second object within the path. In an aspect, vehicle display system 110, e.g., in conjunction with one or more ECUs 112, object detector 118, processor 120, memory 122 can determine that the object is obscured by a second object within the path. For example, vehicle display system 110 can detect (e.g., via object detector 118) presence of the second object, which can include utilizing one or more sensors to detect the second object and/or corresponding location information (e.g., a direction and/or distance to the second object). Vehicle display system 110 can also determine that the second object is obscuring the first object based at least in part on the distance and/or direction to each of the first object and the second object. In one example, vehicle display system 110 can determine that at least the obscured object is an animate object (e.g., based on previously detecting the object at another position or otherwise detecting a movement or acceleration of the obscured object). In any case, in an example, the vehicle display system 110 can determine to highlight the object (e.g., based on determining that the object is obscured by the other object) by drawing a beam towards the obscured object, as described herein.

At block 210, method 200 can also include displaying, on the display of the vehicle, a beam drawn from the avatar to the object as an alert of the presence of the object. In an aspect, vehicle display system 110, e.g., in conjunction with one or more ECUs 112, object detector 118, processor 120, memory 122 can display, on the display 114 of the vehicle 102, the beam drawn from the avatar to the object as an alert of the presence of the object. For example, vehicle display system 110 can display the beam drawn from the avatar based on the direction and/or distance from the vehicle 102 to the object, as described. In this example, vehicle display system 110 can interpolate location information of the object determined by the object detector 118 (e.g., a direction and/or distance to the object) to a coordinate space of a drawings area on the display 114 (e.g., drawing area 310 in FIG. 3), and can accordingly display the beam from the avatar to the object based on the interpolated location such to alert an operator of the vehicle as to the presence of the object. As described, the vehicle display system 110 can determine to draw the beam based on detecting the object and/or detecting that the object is obscured by another object. In another example, the vehicle display system 110 can determine to draw the beam based additionally or alternatively on a detected acceleration associated with the object (e.g., based on detecting that the acceleration achieves a threshold).

In an example, displaying the beam at block 210 can optionally include, at block 212, displaying the beam at a beam direction determined based on a direction from the vehicle to the object and at a beam length determined based on the distance from the vehicle to the object. In an aspect, vehicle display system 110, e.g., in conjunction with one or more ECUs 112, object detector 118, processor 120, memory 122 can display, on the display 114 of the vehicle 102, the beam at a beam direction determined based on a direction from the vehicle 102 to the object at a beam length determined based on the distance from the vehicle to the object. As described, for example, the object detector 118 can determine a direction from the object detector 118 to the object, and the vehicle display system 110 can interpolate the direction and/or an associated distance to the coordinate space displayed by the display 114, and can accordingly render the beam in the direction of the object on the display 114. An example is depicted in FIG. 3, where the object (e.g., a person 306) is detected (e.g., by object detector 118), and the display 114 draws the beam 304 from the avatar 302 towards the person 306. In one example, determining to draw the beam 304 can be based on determining that the object (e.g., person 306) is obscured by another object (e.g., a pole 308), or otherwise based on detecting the object, as described.

Additionally, for example, vehicle display system 110 can continue to detect presence of the object over a period of time (e.g., at a polling interval), and can update the display of the beam 304 to indicate the appropriate direction and distance based on the polling as the vehicle 102 can move with respect to the object and/or the object can move as well. Moreover, in an example, the vehicle display system 110 can project multiple beams towards multiple detected objects on the display 114 at a given point in time such to alert the vehicle operator of the multiple objects.

FIG. 3 illustrates an example of a display projected onto a windshield 300 by a vehicle display system 110, as described herein. In an example, the vehicle display system 110 can display the avatar 302 in a drawing area 310, where the vehicle display system 110 can draw the beam 304 within the drawing area 310. For example, the drawing area 310 can correspond to, or at least be included in, an area over which object detector 118 can detect objects (e.g., an area in front of the vehicle), and/or interpolate a position of such objects, as described above. Thus, the object detector 118 can detect objects, such as a person 306 and a pole 308, in front of the vehicle 102. Vehicle display system 110 can determine that the person 306 can be obscured by the pole 308, e.g., based on detecting the person 306 and the pole 308 at similar locations, or overlapping locations from a perspective of the front of the vehicle. In any case, vehicle display system 110 can determine to draw a beam 304 from the avatar 302 to the person 306 by interpolating the distance and/or direction of the person 306 onto the drawing area 310, which can include projecting the beam 304 onto windshield 300 (e.g., along with the avatar 302) in a heads-up display. For example, the beam 304 can be of substantially any configuration, such as a solid line, a dotted or dashed line of fixed or varying dot/dash size or pattern, etc. In addition, the vehicle display system 110 can select a characteristic of the beam 304 (e.g., a color or pattern) to indicate a characteristic of the object, such as a distance to the object (e.g., red color or a dense dot pattern for objects within a first threshold distance, yellow color or a more sparse dot pattern for objects between the first threshold distance and a second threshold distance, type of the object (e.g., a different color or dot pattern for human objects as compared to structural objects), size of the object, etc.

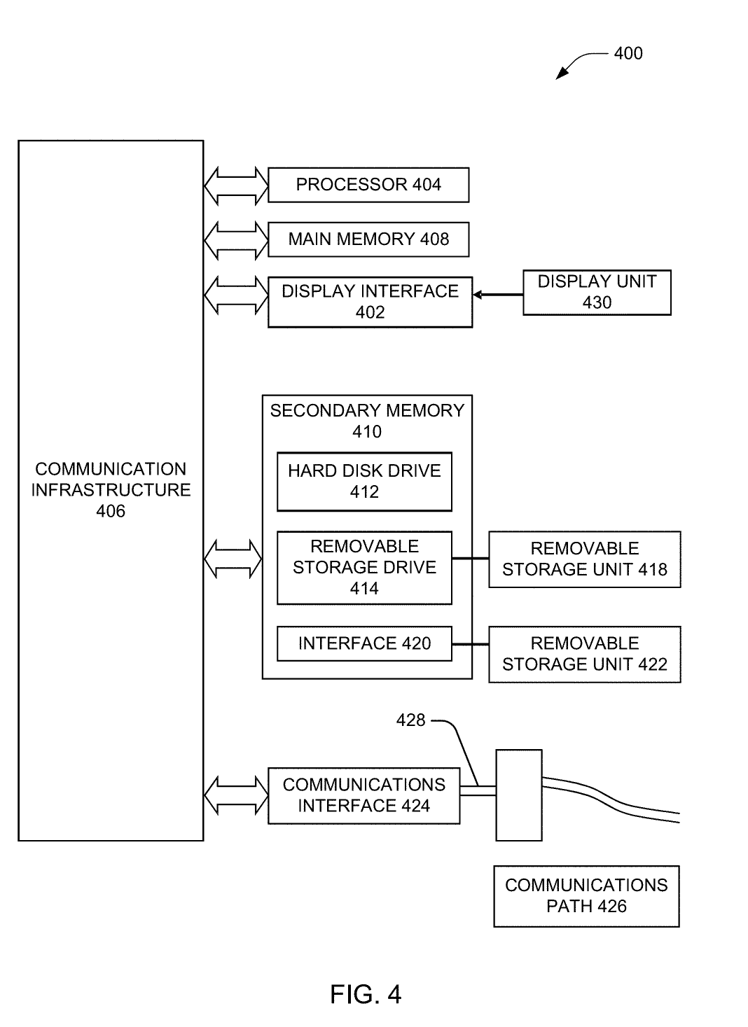

Aspects of the present disclosure can be implemented using hardware, software, or a combination thereof and can be implemented in one or more computer systems or other processing systems. In one aspect, the disclosure is directed toward one or more computer systems capable of carrying out the functionality described herein. An example of such a computer system 400 is shown in FIG. 4.

FIG. 4 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). In one example, processor 120 can include processor 404. Various software aspects are described in terms of this example computer system. After reading this description, it will become apparent to a person skilled in the relevant art(s) how to implement aspects described herein using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and can also include a secondary memory 410. The secondary memory 410 can include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative aspects, secondary memory 410 can include other similar devices for allowing computer programs or other instructions to be loaded into computer system 400. Such devices can include, for example, a removable storage unit 422 and an interface 420. Examples of such can include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400. In an example, memory 122 can include one or more of main memory 408, secondary memory 410, removable storage drive 414, removable storage unit 418, removable storage unit 422, etc.

Computer system 400 can also include a communications interface 424. Communications interface 424 allows software and data to be transferred between computer system 400 and external devices. Examples of communications interface 424 can include a modem, a network interface (such as an Ethernet card), a communications port, a Personal Computer Memory Card International Association (PCMCIA) slot and card, etc. Software and data transferred via communications interface 424 are in the form of signals 428, which can be electronic, electromagnetic, optical or other signals capable of being received by communications interface 424. These signals 428 are provided to communications interface 424 via a communications path (e.g., channel) 426. This path 426 carries signals 428 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. Aspects described herein can be directed to such computer program products.

Computer programs (also referred to as computer control logic) are stored in main memory 408 and/or secondary memory 410. Computer programs can also be received via communications interface 424. Such computer programs, when executed, enable the computer system 400 to perform various features in accordance with aspects described herein. In particular, the computer programs, when executed, enable the processor 404 to perform such features. Accordingly, such computer programs represent controllers of the computer system 400.

In variations where aspects described herein are implemented using software, the software can be stored in a computer program product and loaded into computer system 400 using removable storage drive 414, hard disk drive 412, or communications interface 420. The control logic (software), when executed by the processor 404, causes the processor 404 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

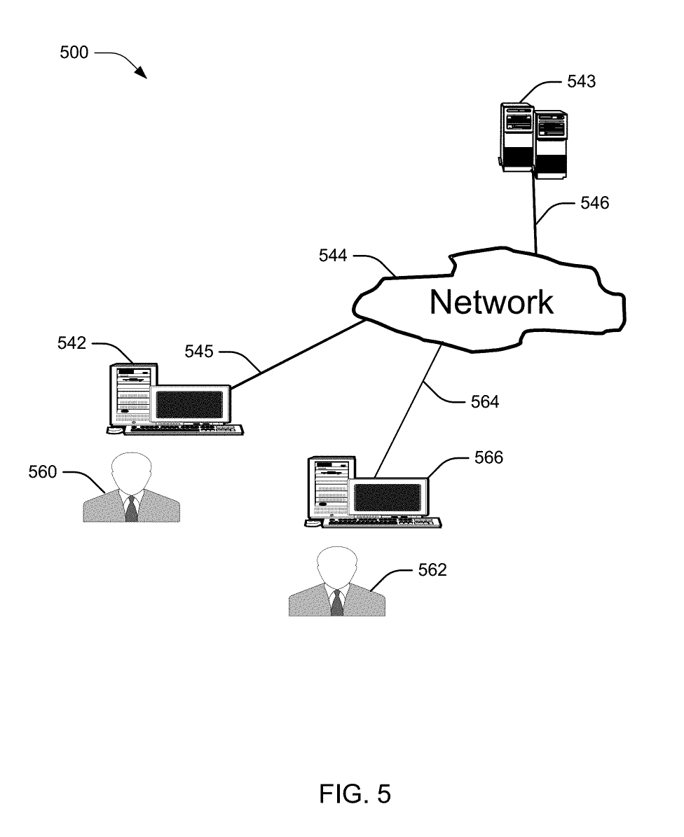

FIG. 5 is a block diagram of various example system components, in accordance with an aspect. FIG. 5 shows a communication system 500 usable in accordance with aspects described herein. The communication system 500 includes one or more accessors 560, 562 (also referred to interchangeably herein as one or more “users”) and one or more terminals 542, 566. For example, terminals 542, 566 can include vehicle 102 or a related system (e.g., vehicle display system 110, processor 120, communications device 116, etc.), remote device 104, and/or the like. In one aspect, data for use in accordance with aspects described herein is, for example, input and/or accessed by accessors 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 1464 include, for example, wired, wireless, or fiberoptic links. In another example variation, the method and system in accordance with aspects described herein operate in a stand-alone environment, such as on a single terminal.

The aspects discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, can be desirably combined into many other different systems or applications. Also that various presently unforeseen or unanticipated alternatives, modifications, variations, or improvements therein can be subsequently made by those skilled in the art which are also intended to be encompassed by the following claims.

1. A method of indicating presence of an object on a display of a vehicle, comprising:
determining, based on an interpolation of a rotational position of a steering column or a wheel of the vehicle, a rotational position of an avatar for indicating a travel direction of the vehicle;
displaying, on the display of the vehicle, an avatar with the rotational position to indicate the travel direction of the vehicle;
detecting presence of the object within a path in the travel direction of the vehicle, wherein the path corresponds to an area on the display of the vehicle;
determining, based on a determined acceleration of the object, to highlight the object; and
displaying, on the display of the vehicle and based on determining to highlight the object, a beam drawn from the avatar to the object as an alert of the presence of the object.

2. The method of claim 1, wherein the display is a heads-up display that projects the avatar and the beam onto a windshield of the vehicle, and wherein the path corresponds to a drawing area on the windshield associated with the heads-up display.

3. The method of claim 1, wherein the one or more sensors on the vehicle detect the presence of the object by identifying the object and determining location information of the object with respect to the vehicle.

4. The method of claim 3, wherein displaying the beam comprises displaying the beam at a beam direction and a beam length determined based on the location information of the object.

5. (canceled)

6. The method of claim 1, further comprising determining, based on detecting presence of the object within the path and using one or more sensors to identify the object and a second object within the path, that the object is obscured by the second object, wherein determining that the object is obscured by the second object is based at least in part on comparing a second direction and a second distance of the second object to a direction and a distance of the object, and wherein displaying the beam is further based at least in part on determining that the object is obscured by the second object.

7. The method of claim 1, wherein displaying the beam is based at least in part on determining that the acceleration of the object achieves a threshold.

8. The method of claim 1, wherein displaying the beam comprises selecting at least a characteristic of the beam based at least in part on a characteristic of the object.

9. The method of claim 1, wherein displaying the avatar comprises rotating the avatar based on the travel direction of the vehicle.

10. A vehicle comprising:
an electronic control unit for communicating with at least one vehicle system;
a display for displaying an avatar based on a travel direction of the vehicle, and a beam to indicate presence of an object near the vehicle; and
at least one processor configured to:
determine, based on an interpolation of a rotational position of a steering column or a wheel of the vehicle, a rotational position of the avatar for indicating a travel direction of the vehicle;
causing display of the avatar with the rotational position on the display to indicate the travel direction;
detect, via the electronic control unit, presence of the object within a path in the travel direction of the vehicle, wherein the path corresponds to an area on the display of the vehicle;
determine, based on a determined acceleration of the object, to highlight the object; and
cause displaying, on the display of the vehicle and based on determining to highlight the object, the beam drawn from the avatar to the object as an alert of the presence of the object.

11. The vehicle of claim 10, wherein the display is a heads-up display that projects the avatar and the beam onto a windshield of the vehicle, and wherein the path corresponds to a drawing area on the windshield associated with the heads-up display.

12. The vehicle of claim 10, wherein the electronic control unit is coupled to the one or more sensors, and wherein the at least one processor is configured to detect the presence of the object by the one or more sensors that identify the object and determine location information of the object with respect to the vehicle.

13. The vehicle of claim 12, wherein the at least one processor is configured to cause display of the beam at a beam direction and a beam length determined based on the location information of the object.

14. (canceled)

15. The vehicle of claim 10, wherein the at least one processor is further configured to determine, based on detecting presence of the object within the path and using one or more sensors to identify the object and a second object within the path, that the object is obscured by the second object, wherein the at least one processor is configured to determine that the object is obscured by the second object based at least in part on comparing a second direction and a second distance of the second object to a direction and a distance of the object, and wherein the at least one processor is configured to cause display of the beam further based at least in part on determining that the object is obscured by the second object.

16. The vehicle of claim 10, wherein the at least one processor is configured to cause display of the beam based at least in part on determining that the acceleration of the object achieves a threshold.

17. The vehicle of claim 10, wherein the at least one processor is configured to cause display of the beam by selecting at least a characteristic of the beam based at least in part on a characteristic of the object.

18. The vehicle of claim 10, wherein the at least one processor is further configured to cause display of the avatar at least in part by rotating the avatar based on the travel direction of the vehicle.

19. A non-transitory computer-readable medium storing computer executable code that when executed by a computer, causes the computer to indicate presence of an object on a display of a vehicle, comprising code for:
determining, based on an interpolation of a rotational position of a steering column or a wheel of the vehicle, a rotational position of an avatar for indicating a travel direction of the vehicle;
displaying, on the display of the vehicle, an avatar with the rotational position to indicate the travel direction of the vehicle;
detecting presence of the object within a path in the travel direction of the vehicle, wherein the path corresponds to an area on the display of the vehicle;
determining, based on a determined acceleration of the object, to highlight the object; and
displaying, on the display of the vehicle and based on determining to highlight the object, a beam drawn from the avatar to the object as an alert of the presence of the object.

20. The non-transitory computer-readable medium of claim 19, wherein the display is a heads-up display that projects the avatar and the beam onto a windshield of the vehicle, and wherein the path corresponds to a drawing area on the windshield associated with the heads-up display.

21. The method of claim 1, wherein the avatar has an angular edge that, based on the rotational position, points in the travel direction of the vehicle.

22. The vehicle of claim 10, wherein the avatar has an angular edge that, based on the rotational position, points in the travel direction of the vehicle.
